(19) United States
(12) Patent Application Publication
(10) Pub. No.: US 2009/0239201 A1
(43) Pub. Date: Sep. 24, 2009

(54) PHONETIC PRONUNCIATION TRAINING DEVICE, PHONETIC PRONUNCIATION TRAINING METHOD AND PHONETIC PRONUNCIATION TRAINING PROGRAM

(76) Inventor: Richard A Moe, Tokyo (JP)

Correspondence Address: YOUNG & THOMPSON, 209 Madison Street, Suite 500, ALEXANDRIA, VA, 22314, US

(21) Appl. No.: 11/995,773

(22) PCT Filed: Jul. 15, 2005
(86) PCT No.: PCT/JP2005/013525

§ 371 Date: Jan. 15, 2008

(51) Int. Cl. G09B 19/06; G10L 11/00

(52) U.S. Cl. 434/157; 704/E13.005; 704/8; 704/270

(57) ABSTRACT

A phonetic pronunciation training device, phonetic pronunciation training method, and phonetic pronunciation training program is provided wherein pronunciation and sounds in language acquisition can be self-learned and listening skills, spelling skills and vocabulary can be enhanced. The present invention comprises at least a data base for storing phonetic pronunciation data associated with phonetic data and phonetic symbol data indicating this phonetic data, a selection function block for receiving instruction signal from an input means and randomly selecting phonetic pronunciation data, a phonetic pronunciation data reproducing function for reproducing selected phonetic pronunciation data, and a phonetic symbol data correct/error determination function block for comparing phonetic symbol data input by the input means and phonetic symbol data corresponding to the selected phonetic pronunciation data and recording the correct/error result to a memory means.

### TECHNICAL FIELD

The present invention relates to a phonetic pronunciation training device, phonetic pronunciation training method and phonetic pronunciation training program and enables learning of spelling corresponding to phonetic symbols further corresponding to pronounced voice and this voice.

### BACKGROUND ART

Conventionally, reading comprehension skills, writing skills and conversation skills must be acquired, respectively, as the three biggest elements of language learning. Out of these skills, when focus is placed on conversation skills, it is based on listening skills and the acquisition thereof is vital. In other words, by listening correctly, the contents of the statements made by a conversation partner can be accurately understood.

In addition, in order to acquire correct listening skills, it is important to learn the sounds of each vocabulary level. This is because, by being able to accurately catch the sound of each word, not only one sentence but the entire conversation can be understood.

In addition, it is necessary to understand pronunciation by phonetic symbols in order to learn sounds of each vocabulary level. This is because, by knowing the correct phonetic symbols, the pronunciation of each word can be understood and correct pronunciation, as well as listening without mishearing, is possible.

On the other hand, with regards to phonetic symbols, words, sentences and conversation, they must all be understood and grasped through hearing the sounds from a native speaker, the reason being, a native speaker will make correct pronunciations.

As a method for learning these phonetic symbols, Japanese Patent Laid-open Publication 2000-250402 has been proposed as a foreign language pronunciation learning device. This Japanese Patent Laid-open Publication 2000-250402 proposes a device for teaching pronunciation be alternately reproducing model sound data and the student's sound data and comparing the two data.

However, although learning pronunciation important and necessary to enhance conversation skills, it was found that the first step is to sufficiently strengthen listening skills. In other words, it has become clear that listening skills in foreign language acquisition can be improved and, at the same time, pronunciation skills can be enhanced by improving listening skills to a point wherein the actual sound and phonetic symbols correspond.

Meanwhile, when learning pronunciation in particular when acquiring foreign languages in Japan, phonographic katakana transcription is often used, rather than phonetic symbols. This causes situations wherein accurate pronunciations are not acquired because, although there are advantages facilitating the learning of pronunciation, the sounds of katakana do not correspond respectively to the phonetic symbols of foreign words, and therefore, the pronunciation of these words are understood as katakana. Furthermore, situations have occurred wherein conversations with native speakers could not be established.

A major factor to this is that correct phonetic symbols are not studied. Although the fact that school education placed little importance of phonetic symbols contributes to why correct phonetic symbols are not studied, that suitable learning methods have not been proposed is also a major factor. There are very few chances to verify correct phonetic symbols by sound and insufficient provision of such teaching materials.

Furthermore, even if there are teaching materials, one which corresponds and indicates phonetic symbols and the sounds thereof have been proposed heretofore. However, it is difficult to say that there is sufficient provision of teaching materials which objectively assess the degree of comprehension regarding phonetic symbols.

In other words, issues are arising in that there is a lack of teaching material enabling learning by corresponding phonetic symbols and the phonation of native speakers.

In addition, further issues are arising in that, in self-learning of languages, it is difficult to learn while objectively grasping respective comprehension of phonetic symbols.

Therefore, the object of the present invention is to provide a phonetic pronunciation training device, phonetic pronunciation training method and phonetic pronunciation training program enabling self-learning of pronunciations and phonetics in language acquisition and increase in listening skills, spelling skills and vocabulary, to resolve the foregoing issues.

### DISCLOSURE OF THE INVENTION

In order to resolve the foregoing issues, the phonetic pronunciation training device according to the present invention comprises at least: a data base for storing phonetic pronunciation data associated with phonetic data and phonetic symbol data indicating this phonetic data; a selection function block for receiving instruction signal from an input means and randomly selecting phonetic pronunciation data; a phonetic pronunciation data reproducing function for reproducing selected phonetic pronunciation data; and a phonetic symbol data correct/error determination function block for comparing phonetic symbol data input by the input means and phonetic symbol data corresponding to the selected phonetic pronunciation data and recording the correct/error result to a memory means.

The foregoing phonetic symbol data is further characterized by letter data corresponding to phonetic symbol data being recorded to the database, and the correct/error determination function block comparing the character data input from an outside source and the character data corresponding to the selected phonetic pronunciation data and recording this correct/error result to the memory means.

A calculation function block for adding the correct/error results determined by the phonetic symbol data correct/error determination function block and calculating the correct/error rates and comparison frequency is further comprised.

A display function block for displaying the calculation results from the calculation function block to the display part is further comprised.

An access management function block for recording, to the memory means, the correct/error rates and comparison frequency calculated by the calculation function block for every person making an access is further comprised.

In the phonetic pronunciation training method according to the present invention, phonetic pronunciation data which correlates sound data and phonetic symbol data indicating this sound data is stored to the database beforehand; the selection function block receives instruction signals from an input means and randomly selects phonetic pronunciation data; the phonetic pronunciation data reproducing function block reproduces the selected phonetic pronunciation data; and the phonetic symbol data correct/error determination function block compares the phonetic symbol data input from the input means and the phonetic symbol data corresponding to the selected phonetic pronunciation data and records the correct/error results to the memory means.

In the phonetic pronunciation training program, phonetic pronunciation data which correlates sound data and phonetic symbol data indicating this sound data is stored to the database beforehand; the selection function block receives instruction signals from an input means and randomly selects phonetic pronunciation data; the phonetic pronunciation data reproducing function block reproduces the selected phonetic pronunciation data; and the phonetic symbol data correct/error determination function block compares the phonetic symbol data input from the input means and the phonetic symbol data corresponding to the selected phonetic pronunciation data and records the correct/error results to the memory means.

### BRIEF DESCRIPTION OF DRAWINGS

FIG. 1 is a block diagram showing a first embodiment of a phonetic pronunciation training device according to the present invention;

FIG. 2 is a flowchart of a main program in a first embodiment of a phonetic pronunciation training method and phonetic pronunciation training program according to the present invention;

FIG. 3 is a flowchart of a main program in a first embodiment of a phonetic pronunciation training method and phonetic pronunciation training program according to the present invention;

FIG. 4 is a flowchart of a sub program in a first embodiment of a phonetic pronunciation training method and phonetic pronunciation training program according to the present invention;

FIG. 5 is flowchart of a sub program in a first embodiment of a phonetic pronunciation training method and phonetic pronunciation training program according to the present invention;

FIG. 6 is a flowchart of a sub program in a first embodiment of a phonetic pronunciation training method and phonetic pronunciation training program according to the present invention;

FIG. 7 is a flowchart of a sub program in a first embodiment of a phonetic pronunciation training method and phonetic pronunciation training program according to the present invention;

FIG. 8 is a flowchart of a sub program in a first embodiment of a phonetic pronunciation training method and phonetic pronunciation training program according to the present invention;

FIG. 9 is a flowchart of a sub program in a first embodiment of a phonetic pronunciation training method and phonetic pronunciation training program according to the present invention;

FIG. 10 is a diagram of a screen configuration of a main program in a first embodiment of a phonetic pronunciation training method and phonetic pronunciation training program according to the present invention;

FIG. 11 is a block diagram of a second embodiment of a phonetic pronunciation training device according to the present invention;

FIG. 12 is a flowchart of a main program in a second embodiment of a phonetic pronunciation training method and phonetic pronunciation training program according to the present invention;

FIG. 13 is a flowchart of a main program in a second embodiment of a phonetic pronunciation training method and phonetic pronunciation training program according to the present invention;

FIG. 14 is a flowchart of a sub program in a second embodiment of a phonetic pronunciation training method and phonetic pronunciation training program according to the present invention;

FIG. 15 is flowchart of a sub program in a second embodiment of a phonetic pronunciation training method and phonetic pronunciation training program according to the present invention;

FIG. 16 is a flowchart of a sub program in a second embodiment of a phonetic pronunciation training method and phonetic pronunciation training program according to the present invention;

FIG. 17 is a flowchart of a sub program in a second embodiment of a phonetic pronunciation training method and phonetic pronunciation training program according to the present invention;

FIG. 18 is a flowchart of a sub program in a second embodiment of a phonetic pronunciation training method and phonetic pronunciation training program according to the present invention;

FIG. 19 is a flowchart of a sub program in a second embodiment of a phonetic pronunciation training method and phonetic pronunciation training program according to the present invention;

FIG. 20 is a flowchart of a sub program in a second embodiment of a phonetic pronunciation training method and phonetic pronunciation training program according to the present invention;

FIG. 21 is a flowchart of a sub program in a second embodiment of a phonetic pronunciation training method and phonetic pronunciation training program according to the present invention;

FIG. 22 is a flowchart of a sub program in a second embodiment of a phonetic pronunciation training method and phonetic pronunciation training program according to the present invention;

FIG. 23 is a flowchart of a sub program in a second embodiment of a phonetic pronunciation training method and phonetic pronunciation training program according to the present invention;

FIG. 24 is a diagram of a screen configuration of a main program in a second embodiment of a phonetic pronunciation training method and phonetic pronunciation training program according to the present invention;

FIG. 25 is a diagram of a screen configuration of a main program in a second embodiment of a phonetic pronunciation training method and phonetic pronunciation training program according to the present invention; and

FIG. 26 is a diagram of a screen configuration of a main program in a second embodiment of a phonetic pronunciation training method and phonetic pronunciation training program according to the present invention.

### BEST MODE OF CARRYING OUT THE INVENTION

Other details, advantages and characteristics of the present invention are clarified by the embodiments described below, with reference to the attached drawings.

### First Embodiment

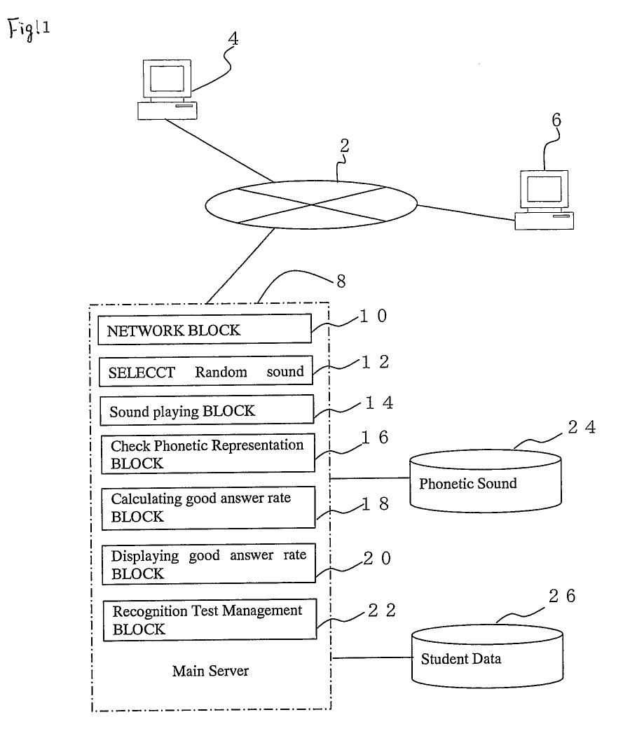

FIG. 1 is a block diagram of a first embodiment of a phonetic pronunciation training device of the present invention. The first embodiment of the phonetic pronunciation training device is a device which conducts a phonetic symbol test.

The phonetic pronunciation training device according to the present invention, shown in FIG. 1, comprises an instructor-side terminal device 4 which is connected to network 2, a student-side terminal device 6, and a main server 8. Both instructor-side terminal device 4 and student-side terminal device 6 can be placed freely in places such as the home or schools. The instructor-side terminal device 4 is a personal computer used by the instructor or other information transmitting/receiving terminals. In the same way, the student-side terminal device 6 is also an information terminal such as a personal computer. Network 2 is an arbitrary network such as intranet, internet, or telephone network.

Main server 8 has both a function to output phonetic symbol practice screens, demonstrations, phonetic symbol practice exercises and test questions to the student-side terminal and a function to output management information such as student participation and performance to the instructor-side terminal device. The instructor activates the instructor-side terminal device 4, connects to main server 8 via network 2, and manages and confirms student performance. In addition, the student activates the student-side terminal device 6, connects to main server 8 via network 2, participates in phonetic symbol practice exercises and test questions, and views test results, as well.

In order to actualize these functions, the main server comprises a network function block 10, a selection function block 12, a phonetic pronunciation data reproducing function 14, a phonetic symbol data correct/error determination function block 16, a calculation function block 18, a display function block 20, an access management function block 22, a phonetic symbol database 24, and a student database 26.

The selection function block 12 receives instruction signals from an input means and randomly selects phonetic pronunciation data. Here, as input means, a keyboard, stylus pen, touch board, mouse or the like is connected to the instructor-side terminal device 4, the student-side terminal device 6 and the main server 8. If operation is made by the input means connected to the main server 8, selection can be made directly from these input means. However, if selection is made from the input means of the instructor-side terminal device 4 and the student-side terminal device 6, the signal is input via instructor-side terminal device 4, student-side terminal device 6, and network 2. This is configured such that, based on the signals from this input means, arbitrary data is selected by a method predetermined by the phonetic symbol database 24, stored beforehand.

The phonetic pronunciation data reproducing function 14 reproduces the selected phonetic pronunciation data by a sound device such as a speaker provided in the manipulated instructor-side terminal device 4, student-side terminal device 6 and the main server.

The phonetic symbol data correct/error determination function block 16 compares the phonetic symbol input again from the input means, after the student listens to the reproduced phonetic pronunciation data, and the phonetic symbol corresponding to the phonetic pronunciation data initially selected the selection function block 12. This comparison result is recorded by the student to the student database 26, which is a memory means, for every student as the correct/error result.

The calculation function block 18 adds the correct/error results determined by the phonetic symbol data correct/error determination function block and calculates the correct/error rate and comparison frequency.

The display function block 20 displays pronunciation method images, operation button images, phonetic symbols, correct/error information and, furthermore, calculation results from the calculation function block to a display part.

The access management function block 22 records the correct/error rate and comparison frequency calculated by the calculation function block to the student database 26, which is a memory means, for every student and manages image display based on the students participation history, as well.

The phonetic symbol database 24 records sound data and phonetic symbols corresponding to the sound data.

The student database 26 records the number of times answered, the percentage of correct answers, and question level, heretofore.

The selection function block 12, phonetic pronunciation data reproducing function 14, phonetic symbol data correct/error determination function block 16, calculation function block 18, display function block 20, access management function block 22 and the like of main sever 5 are composed by computer programs and the like executed by a processor within the main server.

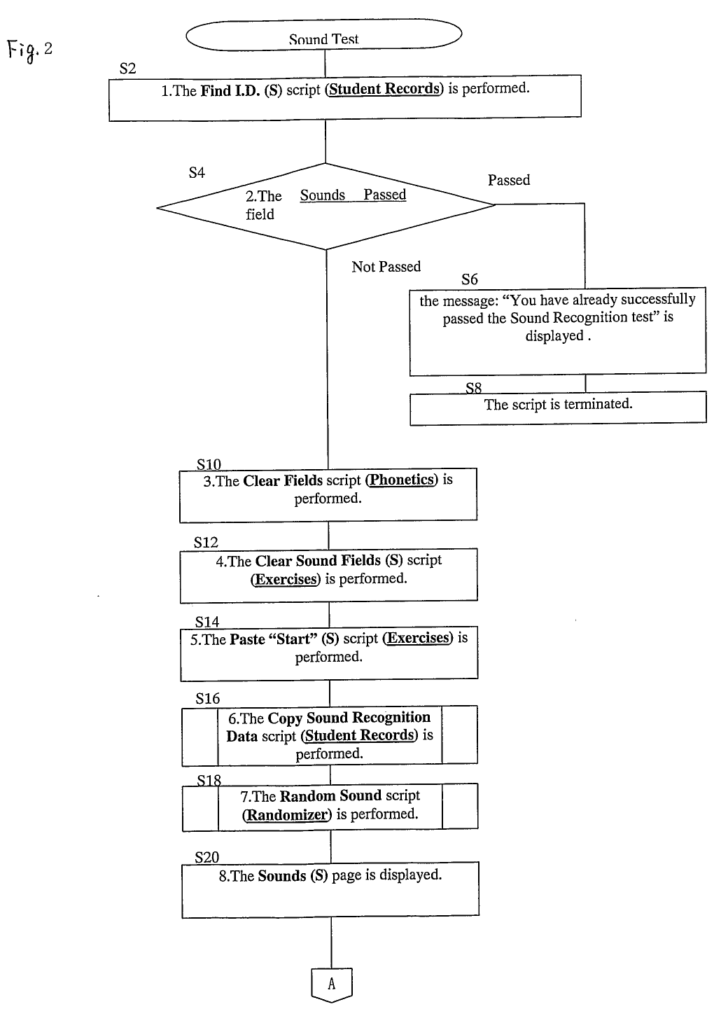

FIG. 2 is the main flow of the program operating by the configuration within the main server 5, shown in FIG. 1.

(Main Script)

The first embodiment is a listening test for phonetic symbols. If the phonetic pronunciation training program is activated prior to the first embodiment, a mode selection screen is displayed on the screen of the device to be operated. The modes are single-user mode and multiple-user mode. A selectable button is displayed respectively. When either button is selected, an ID and password entry screen is displayed. The ID and password entry screen has a blank part for ID and password, respectively. When ID and password is respectively entered in the blank parts, ID retrieval script is executed (S2).

The ID retrieval script first activates retrieval mode. Next, the student database 26 is accessed by the access management function block 22, and ID data is retrieved. Then, the password is detected. Subsequently, this password is compared to the entered password and certification is performed.

Next, the access management function block 22 refers to the pass/fail result of the phonetic symbol test of the entered student ID by the student database 26 (S4). Here, if there is pass-information in the pass/fail result of the phonetic symbol test of the student ID, “You have already successfully passed the Sound Recognition test” is displayed by the display function block 20 (S6). Subsequently, the phonetic symbol examination is completed (S8).

On the other hand, if there is fail-information in the pass/fail result of the phonetic symbol test of the student ID, a clear field script is executed (S10).

In the clear field script, first, the display function block 20 displays the phonetic symbol student information. Next, the records of Hold Symbol Item 40, Result Item 42 and Used Item 44, recorded in the student database 26, are deleted by the access management function block 22. In other words, it is reset.

Next, a clear sound field script is executed (S12). In the clear sound field script, data in the following areas of the student database are deleted by the access management function block 22. The specific areas to be deleted are: “Sound Item 46”, “Phonetic Representation Item 48”, “Mouth Position Item 50”, “Sound Result Item 52”, “Correct Symbols Item 54”, “Sound Errors Item 56”, “Correct Sounds Item 58”, “Sound Attempts Item 60”, “Sound Correct Item 62”.

Furthermore, the cursor is moved to a Phonetic Representation Display Box 70 (on the screen of the system of the present invention) on the screen or, in other words, a frame part indicating phonetic symbols.

Next, a paste start script is executed (S14). In this paste start script, first, the display function block 20 displays phonetic symbol student information. Furthermore, it is stored to Phonetic Representation Item 48 in the student database 26 by access management function block 22.

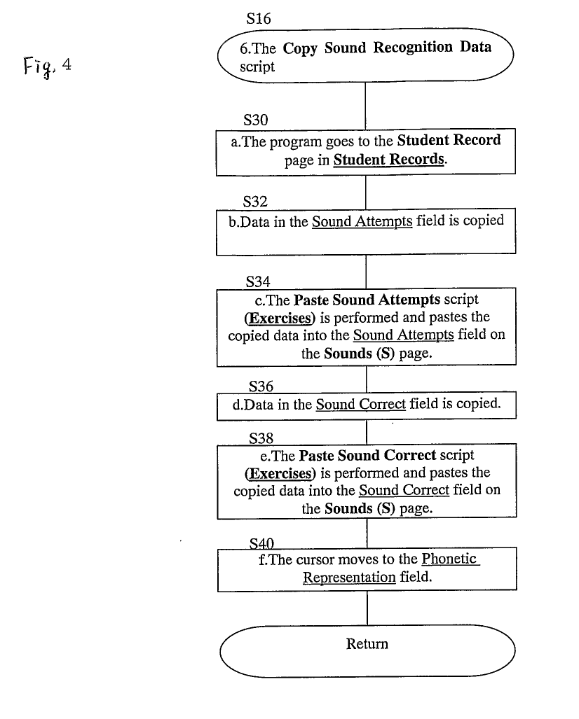

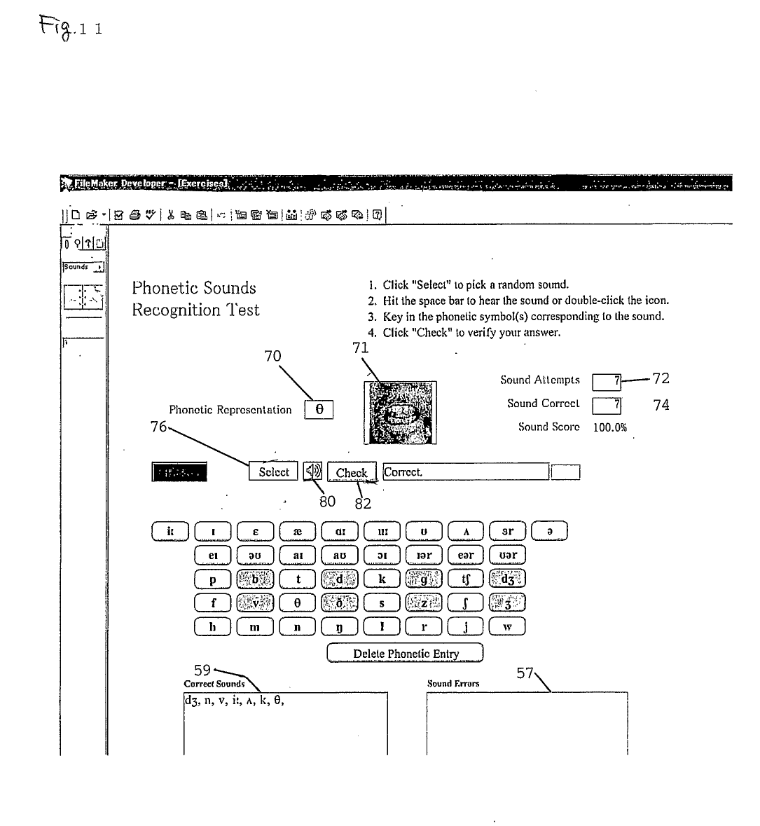

Then, a speech recognition data copy script is executed (S16). This script displays the “Sound Attempt” display box 72 which is the number of times attempts have been made to answer a question (on the screen of the system of the present invention) FIG. 11 and the “Sound Correct” display box 74 which shows the number of times an answer was correct, and the details are shown in FIG. 4.

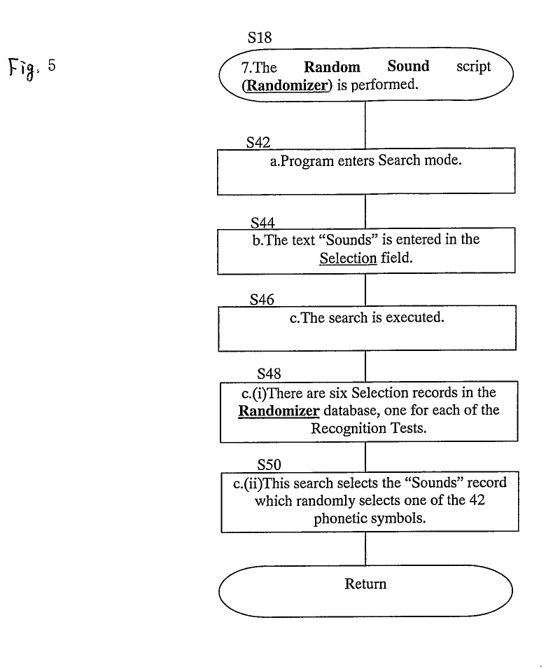

Furthermore, a random sound script is executed (S18). The random sound script is a script for selecting phonetic symbols to be reproduced as questions based on random numbers, and the details are shown in FIG. 5.

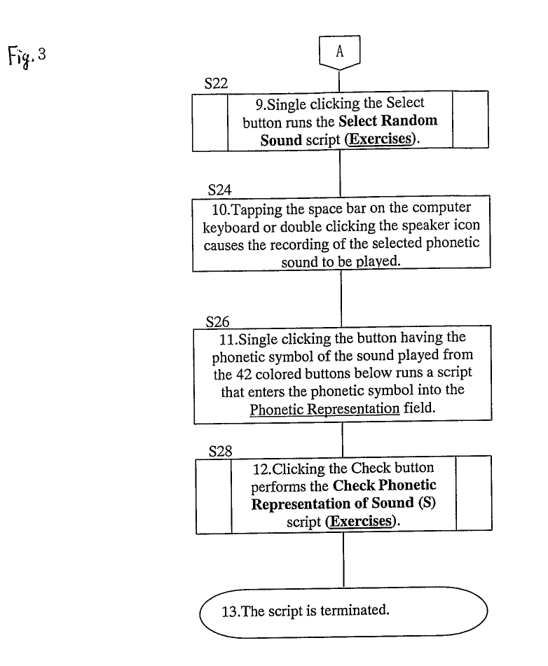

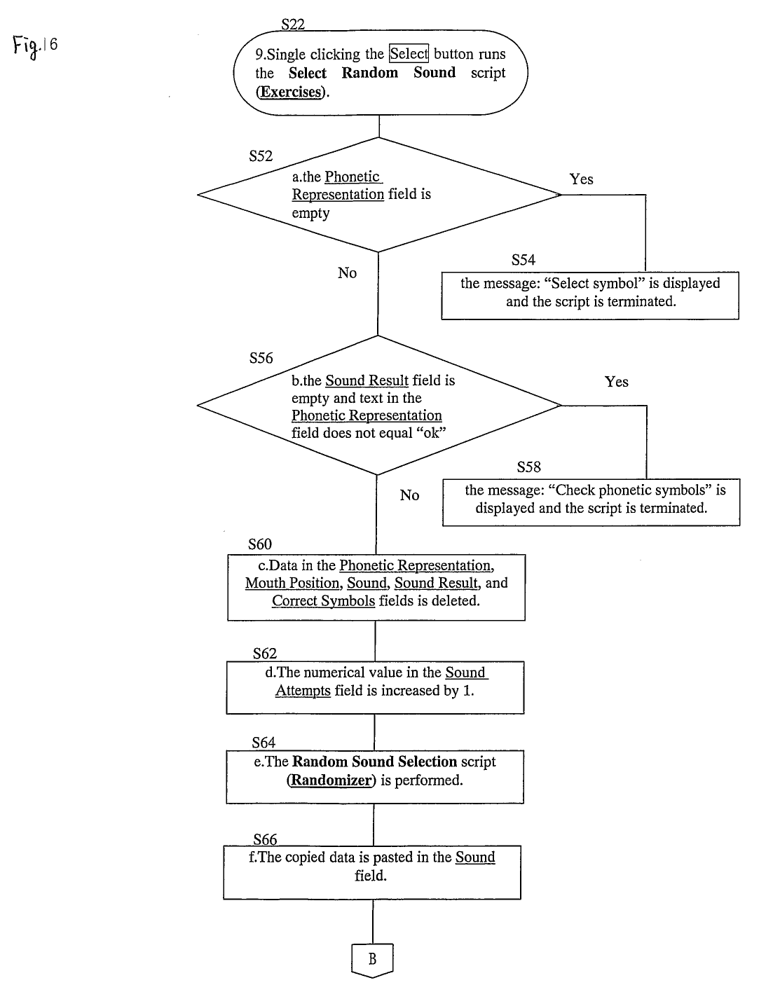

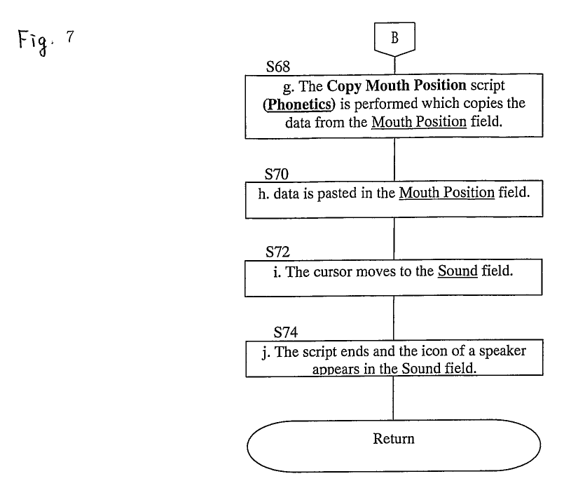

Next, a phonetic symbol page is displayed by display function block 20 (S20). Furthermore, connecting to A in FIG. 3 via A in FIG. 2, a select random sound script is activated with a click to a select button 76 by the selection function block 12 (S22). The details are shown in FIG. 6 and FIG. 7.

In addition, either a space key 78 (not illustrated and provided in a keyboard for input which is connected to the system) or a speaker icon 80 shown on the screen is selected, and the phonetic pronunciation data reproducing function 14 reproduces a recording of the selected phonetic symbol (S24).

Next, by selecting the phonetic symbol of the reproduced sound, the phonetic symbol is stored to Phonetic Representation Item 48 of the student database 26 (S26).

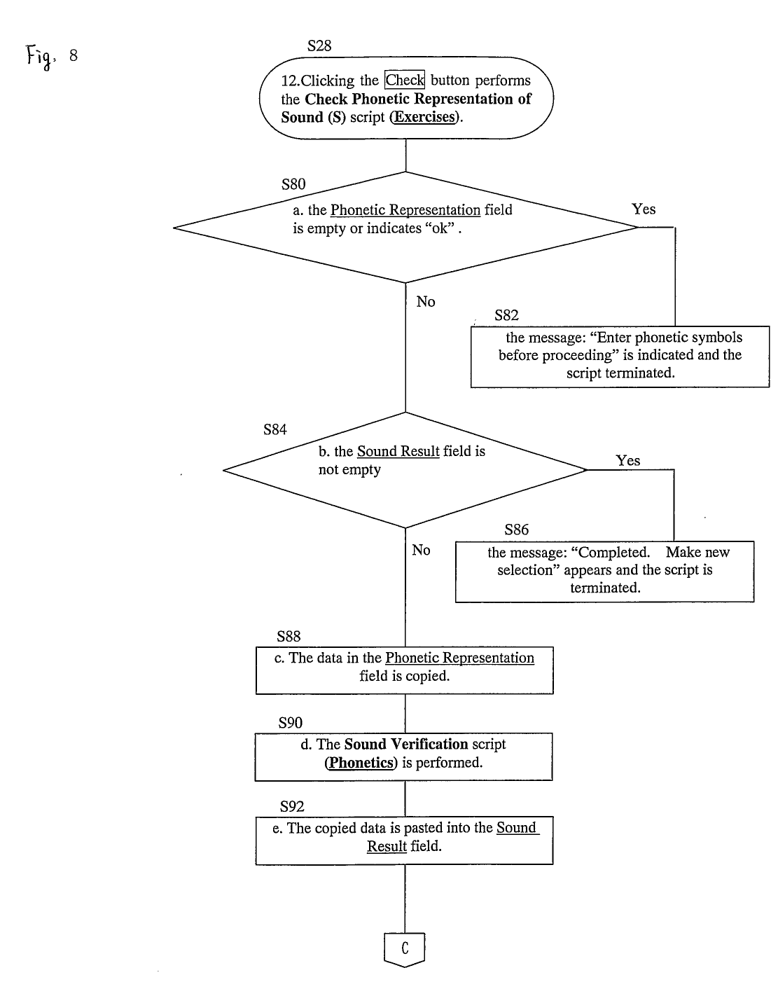

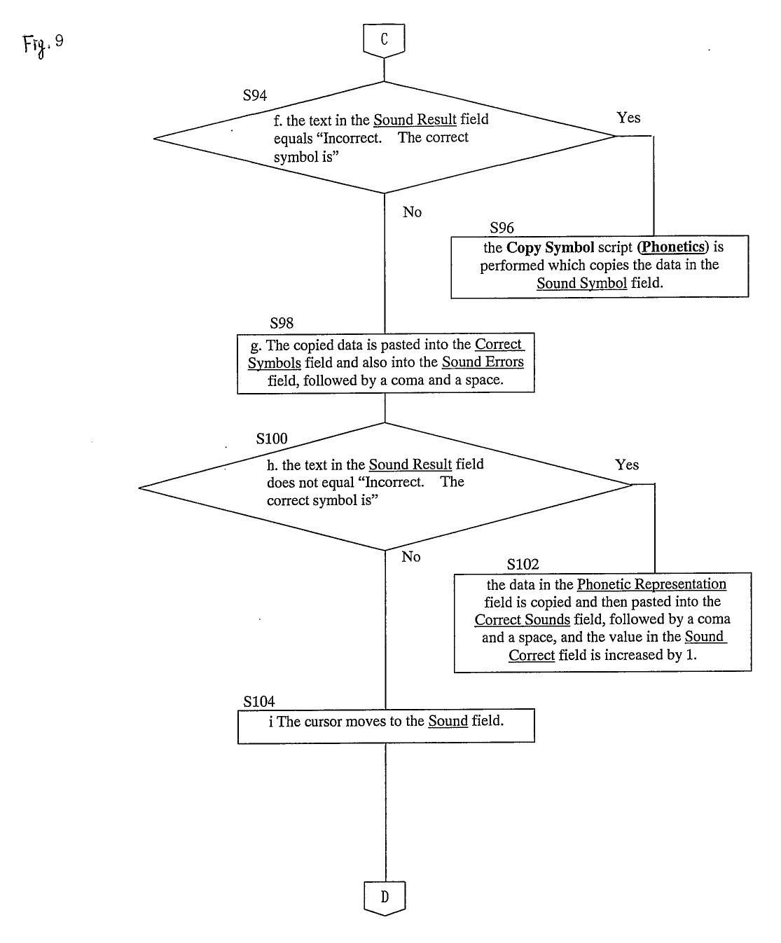

Furthermore, by selecting check button 82, the phonetic symbol data correct/error determination function block is activated and a speech recognition script is executed (S28). The details are shown in FIG. 8 and FIG. 9. The listening test of phonetic symbols of the first embodiment is completed by the speech recognition script.

(Speech Recognition Data Copy Script)

The speech recognition data copy script is shown in further detail in FIG. 4. The present script prepares data for calculating the percentage of correct answers.

The speech recognition data copy script in access management function block 22 accesses Student Records 84 of the student database 26 (S30).

Next, by the speech recognition data copy script, data recorded in Sound Attempts Item 60 of student database 26 is saved to temporary memory area part 86 (S32).

Then, by paste sound attempt script, the foregoing data in Sound Attempts Item 60, saved to the temporary memory area part 86, is copied to the sound page of the student database 26 (S34).

Furthermore, by the speech recognition data copy script, Sound Correct Item 62 of the student database 26 is saved to temporary memory area part 86 (S36).

In addition, by paste sound collect script, data in temporary memory area part 86 which has been saved earlier to the sound page of the student database 26 is copied to Sound Correct Item 62 (S38).

The cursor is moved to the Phonetic Representation Display Box 70 on the screen, after which the speech recognition data copy script is completed.

(Random Sound Script)

Next, random sound script which is a script for randomly setting out phonetic symbol questions is described in detail using FIG. 5.

First, the random sound script is set to retrieval mode (S42). Then, the text “SOUND” is entered in the Selection area of the student database 26 (S44), and retrieval is performed (S46).

Furthermore, six types of selection methods are registered beforehand in the Randomizer database of the phonetic symbol database 24 (S48).

Then, “Sound” recording, which randomly selects one out of 42 phonetic symbols through this retrieval, is selected (S48).

By using a random selection method, questions can be set such that the sequence of the questions is unpredictable.

(Select Random Sound Script)

Next, the details of select random script are shown in FIG. 6 and FIG. 7. Select random script is a script for selecting and displaying phonetic symbols.

If the value of Phonetic Representation Item 48 is blank (S52), the display function block 20 displays “Select symbol” on the screen and the script is completed (S54).

If the Phonetic Representation Item 48 of the student database 26 is not blank, the Sound Result Item 52 is blank, and the content of the Phonetic Representation Item 48 does not equal text “ok” (S56), “Check phonetic symbols” is displayed on the screen and the script is completed (S58).

Next, each area of Phonetic Representation Item 48, Mouth Position Item 50, Sound Item 46, Sound Result Item 52, and Correct Symbols Item 54 of student database 26, within the data, is deleted (S60).

Here, the numerical value of Sound Attempts Item 60 increases by 1 (S62).

Next, a random sound selection script (randomizer) or, in other words, a program for selecting phonetic symbols for questioning is executed. Here, when this randomizer is executed, search mode is entered. Then, the text, “Sound”, is entered in selection Item 94 of the student database 26. Retrieval is performed. Random number shown in from Item 88 to Item 90 on the student database 26, which is derived from an algorithm, is stored to number Item 92 of the student database 26. This number Item 92 is stored to the temporary memory area part 86.

Next, a Sound Selection script (phonetics) is executed. First, search mode is entered. The value of number Item 92 stored earlier to the temporary memory part is stored to Sound Number Item 96 of the student database 26. Here, the data in the “Model Sound” area of the student database 26 is stored to the temporary memory area part 86. Then, the value of the “Used” area in the student database 26 is increased by 1.

Next, the data in the Model Sound Item 98 of the student database stored to the temporary memory part is stored to Sound Item 46 (S66).

Then, a “Copy Mouth Position” script copies data in the Mouth Position Item 50 of the student database 26 to the temporary memory area part 86 and is executed (S68).

The data in the temporary memory area part 86 is stored to the Mouth Position Item 50 of the student database 26 (S70).

The cursor is moved to the “Sound” area on the screen (S72).

The script is completed and the speaker icon 80 is shown in the “Sound” area on the screen (S74). Subsequently, it returns to step S22 in FIG. 3.

(Phonetic Symbol Display Check Script)

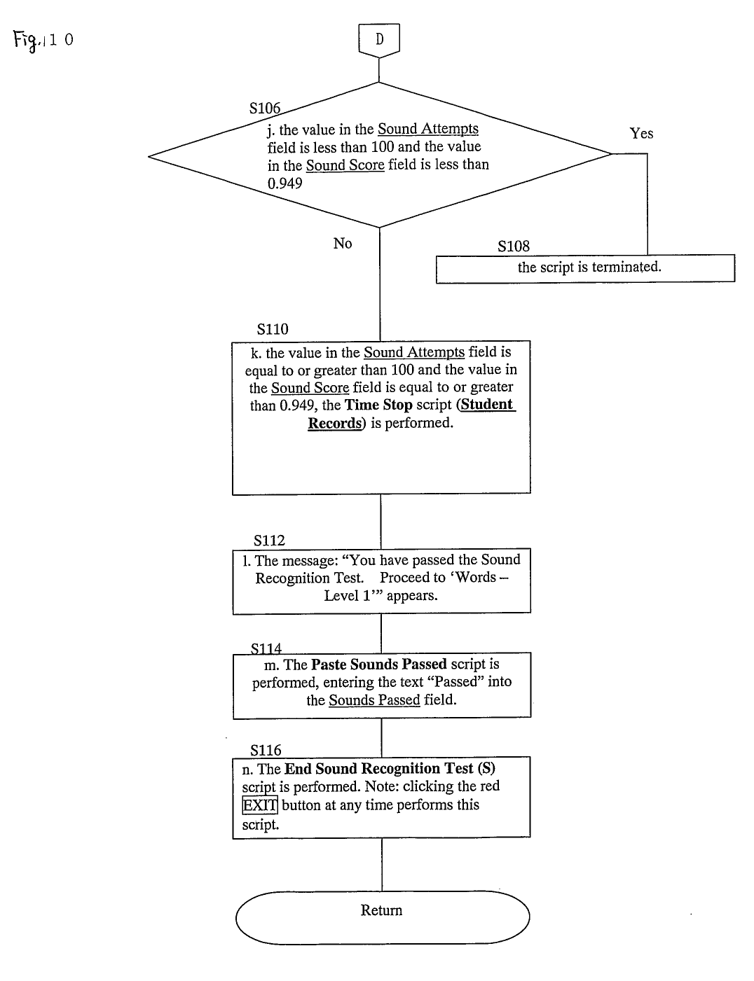

Next, the details of speech-recognition program S28 in the main program is shown using FIG. 8, FIG. 9, and FIG. 10.

First, it is determined whether or not the Phonetic Representation Item 48 in the student database 26 is blank or “ok” is stored thereto (S80). Then, if the Phonetic Representation Item 48 is blank, “Enter Phonetic symbols before proceeding” is shown on the screen and the script is completed (S82).

Next, it is determined whether or not the “Sound Result Item 52” in the student database 26 is empty (S84). If the result is not blank, “Completed. Make new selection” is displayed and the script is completed (S86).

The data in the Phonetic Representation Item 48 is stored to the temporary memory part 86 (S88).

Next, the “Sound Verification” script (Phonetics) is executed (S90).

Here, first, data in the Phonetic Representation Item 48 stored to the temporary memory area part 86 is stored to the Hold Symbol Item 40 in the student database 26.

Then, if the data in the Hold Symbol Item 40 and the data in the Sound Symbol Item 100 match completely, Text “Correct” is entered in the Result Item 42 in the student database 26.

On the other hand, if the data in the Hold Symbol Item 40 and the data in the Sound Symbol Item 100 do not match completely, Text “Incorrect. The correct symbol is” is entered in the Result Item 42 in the student database 26.

Furthermore, the data in the Result Item 42 is stored to the temporary memory area part 86.

Next, the data in the Result Item 42 stored to the temporary memory area part 86 is stored to the Sound Result Item 52 in the student database 26 (S92).

Then, in FIG. 9, it is determined whether the Text in the Result Item 42 in the student database 26 is “Incorrect. The correct symbol is” (S94). If this is correct, the Copy Symbol script is executed. Data in the Sound Symbol Item 100 is copied and the Copy Symbol script completed (S96).

On the other hand, if it differs, the copied data is collected within the Correct Symbol Item 54. In addition, it is also stored to Sound Errors Item 56 (S98).

Next, an instance wherein the Text in the Result Item 42 in the student database 26 is not “Incorrect. The correct symbol is” is shown (S100). In this case, the data in the Phonetic Representation Item 48 is stored to the Correct Sounds Item 58. The value of the Sound Correct Item 62 is increased by 1 (S102).

The cursor is moved to the Sound Display Box 102 on the screen (S104).

In FIG. 10, if the value of the Sound Attempt Item 60 less than 100, and the value of the Sound Score Item 140 is less than 0.949 (S106), the script is aborted (S108).

Next, if the value of the Sound Attempt Item 60 is 100 or more, and the value of the Sound Score Item 140 is 0.949 or more (S106), the script is executed (S108).

Here, a “Time Stop” script implements a statistical layout. Then, the current time is stored to the “STOP” area.

Next, an “Enter Total Practice Time” script is executed. Here, in the “Enter Total Practice Time” script, first, if the Sound Passed Item 106 is blank, the value of Sends Time Item 110 is added to the value of the Time Item 108 and the script is completed.

Second, if the Words Level 1 Passed Item 112 is blank, the value of WL1 Time Item 114 area is added to the value of the “Time Sound Passed” Item 106 area and the script is completed.

Third, if the Words Level 2 Passed Item 116 is blank, the value of WL2 Time Item 118 is added to the value of Time Item 108 and the script is completed.

Fourth, if the Words Level 3 Passed Item 120 is blank, the value of WL3 Time Item 122 is added to the value of Time Item 108 and the script is completed.

Fifth, if the Words Level 4 Passed Item 124 is blank, the value of WL4 Time Item 126 is added to the value of Time Item 108 and the script is completed.

When “Time Stop” script is completed, the cursor moves to the “Practice Dates” area on the screen.

Then, “You have passed the Sound Recognition Test. Proceed to Word-Level” is displayed (S112).

Furthermore, a “Past Sounds Passed” script is executed, and the text “Passed” is stored to the Sound Passed Item 128 (S114).

Next, an “End Sound Recognition Test” script is executed. Here, it should be noted that this script is executed when the “EXIT” button on the screen is clicked by a mouse.

In this “End Sound Recognition Test” script, first, the data in the Sound Attempts Item 60 is stored to the temporary memory area part 86.

Second, a “Paste Sound Attempts” script (Student Records) is executed, and data stored to the temporary memory area part 86 is stored to the Sound Attempt Item 60.

Third, a “Paste Sound Attempts” script (MENU) is executed, and the foregoing stored data is shown in the Display Box 72.

Fourth, data in the Sound Correct Item 62 is stored to the temporary memory area part 86.

Fifth, a “Paste Sound Correct” script (Student Records) is executed, and the data stored to the temporary memory area part 86 is stored to the Sound Correct Item 62.

Sixth, a “Paste Sound Correct” script (MENU) is executed, and the data stored to the temporary memory area part 86 is stored to the “Sound Correct” Display Box 74.

Seventh, the data in Sound Score Item 104 is stored to the temporary memory area part 86 and the cursor moves to the next area on the screen.

Eighth, a “Paste Sound Score” script (Student Records) is executed, and the data stored to the temporary memory area part 86 is stored to the Sound Score Item 104.

Ninth, a “Paste Sound Score” script (MENU) is executed, and the data stored to the temporary memory area part 86 is stored to the Sound Score Item 104.

Next, the display screen when the program according to the present invention is executed is shown in FIG. 11.

In the display screen, the first row shows the title and instructions. The Phonetic Representation Display Box 70, Pronunciation Tongue Position Image 71, “Sound Attempt” Display Box 72, “Sound Correct” Display Box 74, and Sound Score Display Box 75 are allocated to the second row.

The select button 76, speaker icon 80, check button 82, and Result Display Box 83 are allocated to the row below. Furthermore, the phonetic symbol key 77 is allocated to the row further below, and the Correct Sounds Display Block 59 and Sound Errors Display Block 57 are allocated to the lowermost row.

The Phonetic Representation Display Box 70 is a phonetic symbol display part and shows symbols input by the phonetic symbol key 77.

The Pronunciation Tongue Position Image 71 is a display of photographs and illustrations showing the positioning of the tongue, lips and teeth when pronouncing phonetic symbols shown in the Phonetic Representation Display Box 70. “Sound Attempt” Display Box 72 is a box showing the number of attempts made at the present test.

The “Sound Correct” Display Box 74 is a box showing the number of correct answers. This number is the number of correct answers from a predetermined point in time.

The Sound Score Display Box 75 shows the rate of right answers, and the value of Sound Correct divided by Sound Attempt is shown by percentage.

The select button 76 is a start button for determining the question to be given.

The speaker icon 80 is a button for reproducing the sound given as a question.

The check button 82 is a button for verifying whether the phonetic symbols input by the phonetic symbol key 77 matches the question given.

The Result Display Box 83 is a button for displaying the results of the check performed by the check button.

The phonetic symbol key 77 is an alignment of the requisite minimum 42 symbols out of the phonetic symbols. Input is performed through this keyboard.

The Correct Sounds Display Block 59 is a block wherein symbols which were given as questions and answered correctly are shown.

The Sound Errors Display Block 57 is a block wherein symbols were given as questions and answered incorrectly are shown.

By operating as described above, a program which enables the device of the present invention to randomly generate phonetic symbols and calculate the percentage of correct answers for the results thereof can be provided, enabling the study of phonetic symbols through self-learning.

### Second Embodiment

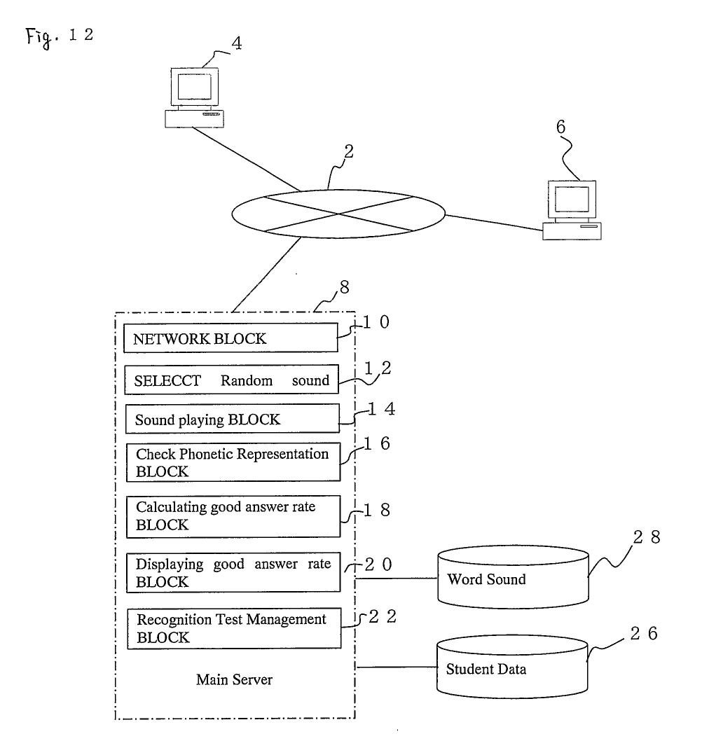

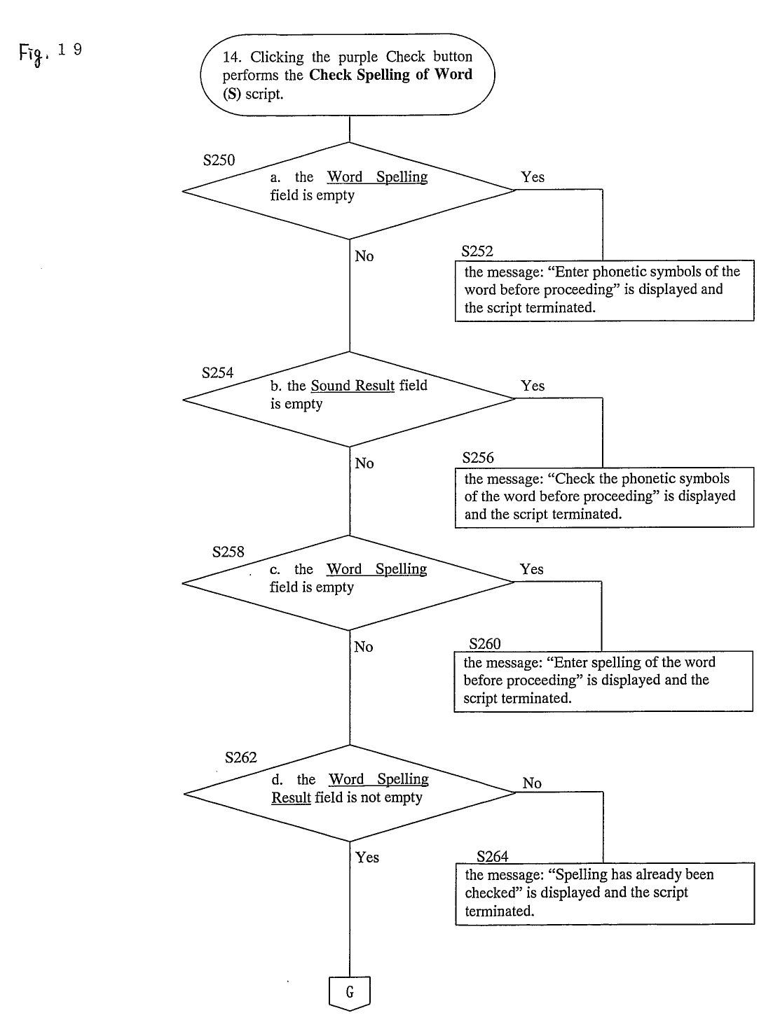

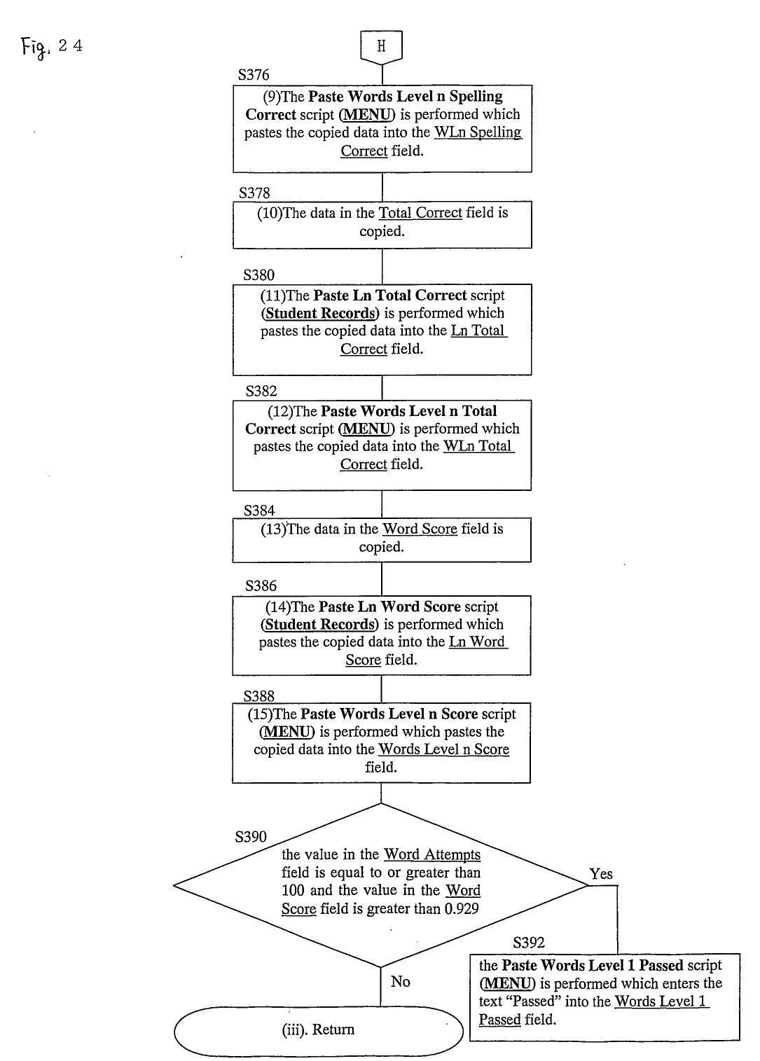

Next, a phonetic pronunciation training program for words according to the present invention is described, with reference to FIG. 12 to FIG. 26.

The difference in the phonetic pronunciation training device according to the present invention with the first embodiment which relates to phonetic symbols is that a word sound database 28 and the main server are connected in stead of the phonetic symbol database 24 shown in FIG. 1 as a database.

The word sound database 28 comprises mainly word spelling information, phonetic symbol notation information, and word sound data information.

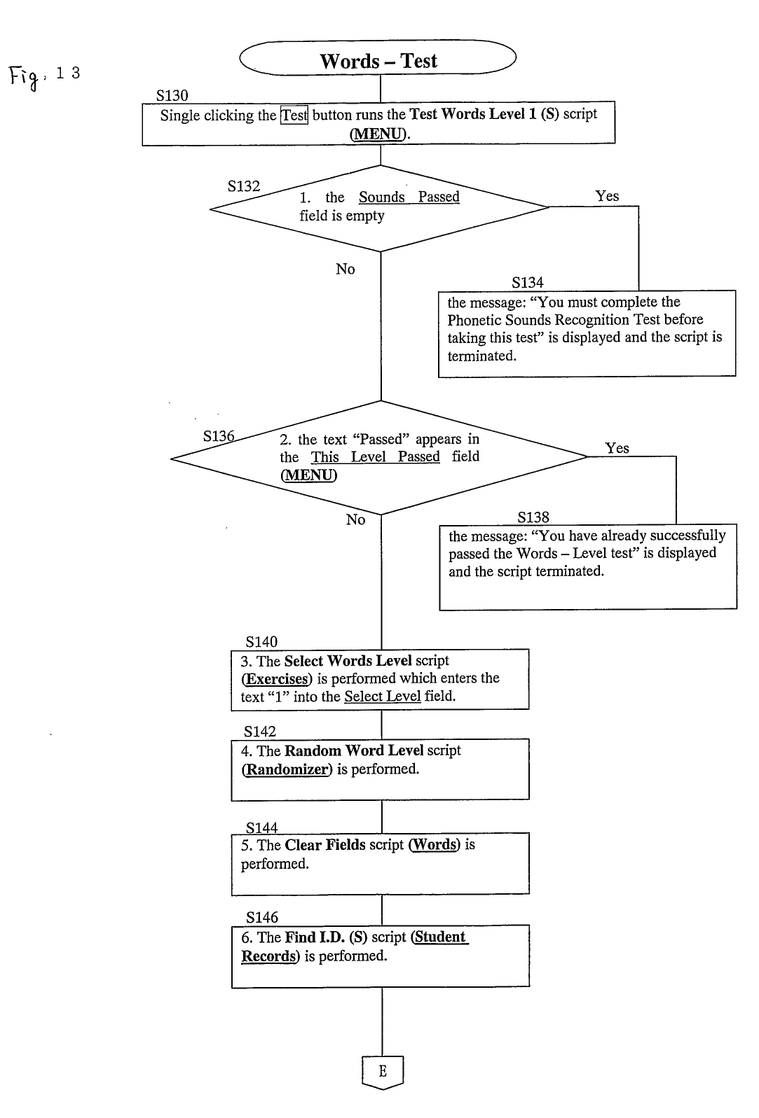

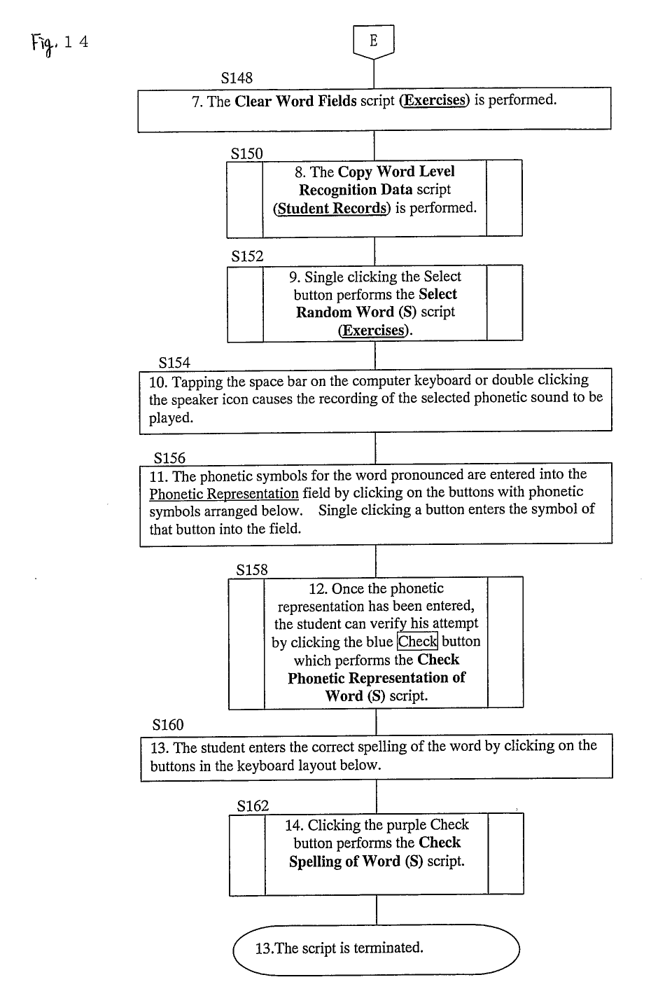

Next, a flowchart of the phonetic pronunciation training method by the phonetic pronunciation training device according to the present invention is described using FIG. 12 to FIG. 23. In particular, FIG. 12 and FIG. 13 show the main flows and FIG. 14 to FIG. 23 show the sub flows.

First, if the “Test” button is selected, a “Test Words Level 1” script, which is the main flow, is executed (S130).

Next, if the “Sound Passed” area is blank (S132), “You must complete the Phonetic Sounds Recognition Test before taking this test” is displayed on the screen and the script is completed (S134).

If the letters “Passed” appear in the “Words Level 1 Passed” area (S136), the message “You have already successfully passed the Words Level 1 test” is shown on the screen and the script is completed (S138).

Furthermore, a “Select Words Level 1” script (Exercise) is executed. The program stores the character “1” to the Select Level Item 132 (S140).

The Random Word Level 1 script (Randomizer) is executed (S142). First, the retrieval mode is activated. Then, the letters “Words Level 1” information is stored to the Selection Item 94. The retrieval mode is completed.

Next, a “Clear Fields” script is executed (S144). In other words, all recordings from the database are extracted. Furthermore, all data recorded to respective areas of Hold Symbol Item 40, Hold Spelling Item 134, Symbols Result Item 136, and Used Item 134 is deleted. Still further, a “Find I.D.” script (Student Record) is executed. First, the retrieval mode is started. Then, the letters “Single User” is entered in the “I.D.” area and recorded. The retrieval mode is completed.

Here, the flow moves to FIG. 13 and a “Clear Word Fields” script (Exercise) is executed (S148). Respective data in the Part of Speech Item 140, Word Spelling Item 142, Word Spelling Result Item 144, Correct Word Spelling Item 146, Phonetic Representation Item 148, Sound Result Item 150, Correct Symbols Item 152, Phonetic Errors Item 154, Spelling Errors Item 156, Word Attempts Item 158, Symbols Correct Item 160, Spelling Correct Item 162, Total Correct Item 164 and Sound Item 166 are deleted. Then, the cursor in the “Phonetic Representation” area moves.

Next, a “Copy Word Level Recognition Data” script (Student Records) is executed (S150. This is shown in further detail, with reference to FIG. 14. First, data in the L1 Word Attempts Item 170 is saved to the temporary memory area part 172 (S170).

Second, a “Paste Word Attempts” script (Exercise) is executed, and the data saved earlier to the temporary memory area part 172 is stored to the Word Attempt Item 174 (S172).

Third, data in the L1 Symbols Correct Item 176 is saved to the temporary memory area part 172 (S174).

Fourth, a “Paste Symbols Correct” script (Exercises) is performed, and the data saved earlier to the temporary memory area part 172 is stored to the Symbols Correct Item 160 (S176).

Fifth, data in the Spelling Correct Item 178 is saved to the temporary memory area part 172 (S178).

Sixth, a “Paste Spelling Correct” script (Exercises) is executed, and the data saved earlier to the temporary memory area part 172 is stored to the Symbols Correct Item 180 (S180).

Seventh, data in the L1 Total Correct Item 182 is saved to the temporary memory area part 172 (S182).

Eighth, a “Paste Total Correct” script (Exercises) is executed, the data saved earlier to the temporary memory area part 172 is stored to the Total Correct Item 164, and the cursor moves to the Phonetic Representation Display Bock 168 on the screen (S184).

Finally, the program opens the “Words(S)ps” page by “Exercises database” (S186). Subsequently, it returns to the “Copy Word Level Recognition Data” script (S150) in the main flow.

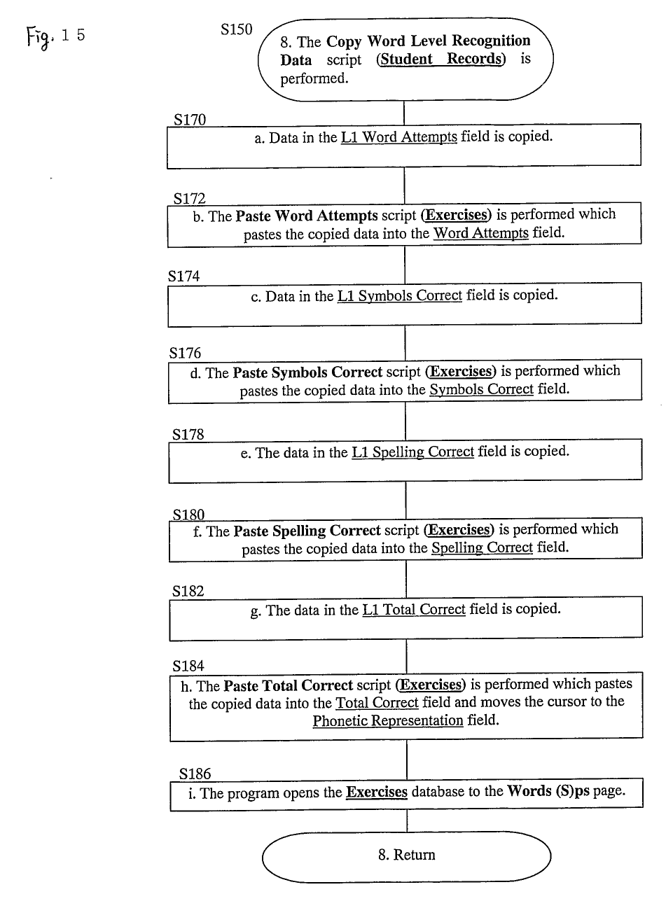

Next, a “Select Random Word (S)” script (Exercise) is executed by single-clicking the Select button 184 (S152). First, it is determined whether or not there is data in the Part of Speech Item 140, with reference to FIG. 15 (S188).

Of there is no data in Part of Speech Item 140, data in Phonetic Representation Item 186, Sound Item 188, Sound result Item 190, Correct symbols Item 192, Word spelling Item 194, Word spelling result Item 196, and Correct Word Spelling Item 198 are deleted (S190).

Then, the value of Word Attempt Item 174 is increased by 1 (S192).

Furthermore, “Wrong button” is displayed on the screen and the script is completed (S194).

On the other hand, if data is stored to Part of Speech Item 140, a “random Word Level n Selection” script (Randomizer) is performed by data n of Level Item 200 (S198). Then, retrieval mode is activated (S200). Letter data “Words Level n” is entered in Selection Item 202 (S202). Retrieval is executed (S204). Then, a random number is generates, input to number Item 204, and entered to the temporary memory area part 172 (S206).

Furthermore, a “Word Selection” script (Words) is executed (S208).

Then, data stored to the temporary memory part 172 is stored to the Sound Item 166 (S210).

Next, “Copy Type” script (Words) is executed and the data in the Type Item 206 is input to the temporary memory area part 172 (S212).

This temporary memory area part 172 data is input to the Part of Speech Item 140 (S214).

Then, the program starts “Words(S)pg layout” (S216). Here, it returns to step (S152).

After step (S152), phonetic symbol sound selected and reproduced by space key input or double-click input of the speaker icon is recorded (S154).

Next, by clicking the phonetic symbol button placed on the lower side of screen, the word pronunciation phonetic symbol is input within the Phonetic Representation Item 148 (S156).

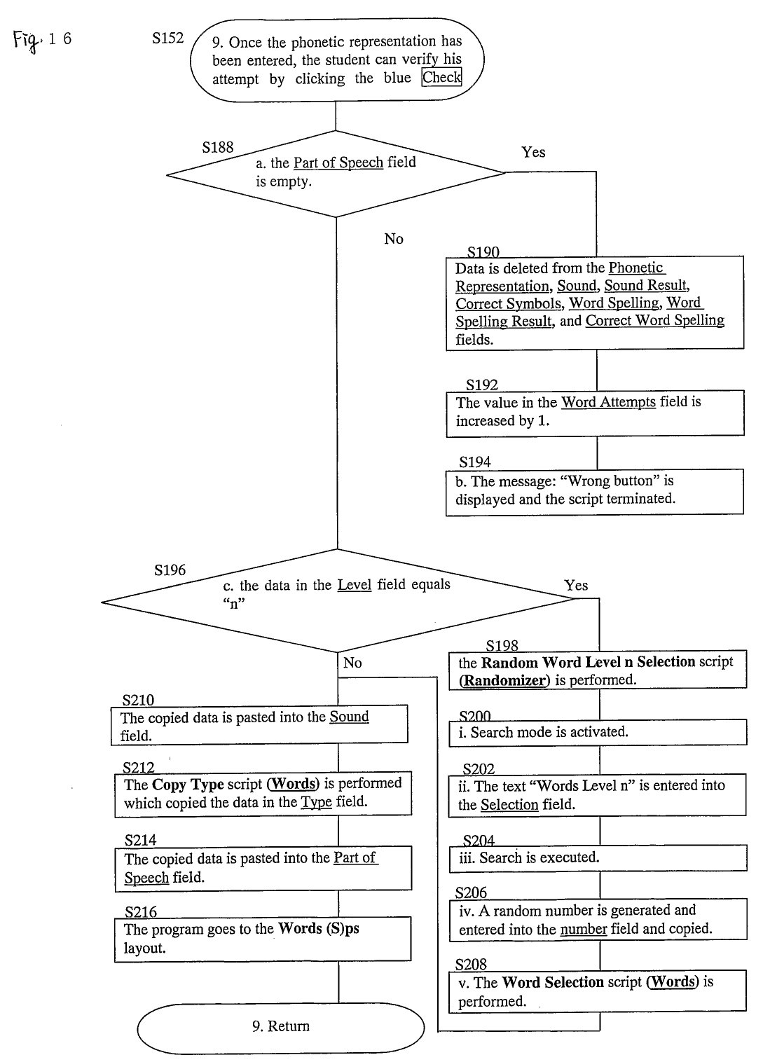

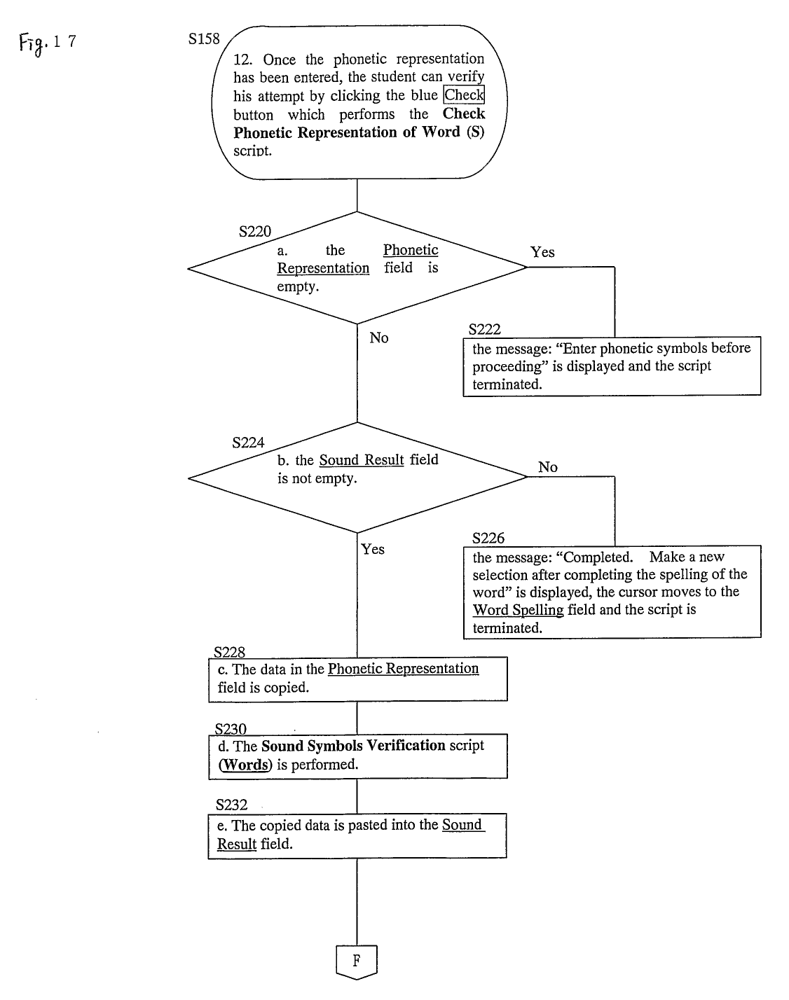

Furthermore, once pronunciation representation is input, the student can confirm attempts at the tests by clicking a blue check button shown on the screen, and a “Check Phonetic Representation of Word(S)” script is executed (S158). Further details are explained using FIGS. 16 and 17.

If the Phonetic Representation Item 186 is blank (S220), “Enter phonetic symbols before proceeding” is shown and the script is aborted (S222).

If the Phonetic Representation Item 186 in not blank and the Sound result Item 190 is not blank (S224), “Completed. Make a new selection after completing the spelling of the word” is shown on the screen, the cursor moves to the Word spelling Display Block 210 on the screen, and the script is aborted (S226).

Next, data in the Phonetic Representation Item 186 is stored to the temporary memory area part 172 by the present program (S228).

Furthermore, a “Sound Symbols Verification” script (Words) is executed (S230). More particularly, first, data saved to the temporary memory part 172 is input to the Hold Symbols Item 212. Second, if the data in the Hold Symbols Item 212 is exactly the same as data in the Phonetic Representation Item 186, the letters “Correct” is input to Symbols Result Item 214. Third, if both data differ, the letters “Incorrect. The correct symbols are” is input to the Symbol Result Item 214. Fourth, data in the Symbols Result Item 214 is saved to the temporary memory area part 172.

Next, data saved to the temporary memory area part 172 is input to the Sound Result Item 150 (S232).

Furthermore, continuing in FIG. 17, if the letters in the Sound Result Item 150 is equal to “Incorrect. The correct symbols are” (S234), a “Copy Symbols” script is executed. Next, the data in the Phonetic Symbols Item 216 (Words) is saves to the temporary memory area part 172. Furthermore, the data saved to the temporary memory area part 172 is stored to the Correct symbols Item 192 and Phonetic Errors Item 218.

Otherwise, the value of the “Symbols Correct” area increases by 1 (S242).

Furthermore, “Words(S)e Layout” is displayed (S244). Subsequently, it returns once again to step (S158) shown in FIG. 13.

Next, the “correct spelling of a Word is input when the student clicks a button located on the lower part of the keyboard layout (S160). First, the spelling in the “Word Spelling” area is input by clicking the button. Second, “Word (S)E layout” is changed by clicking the “shift” button. Third, the “Word (S)E layout” is changed by clicking the “shift” button.

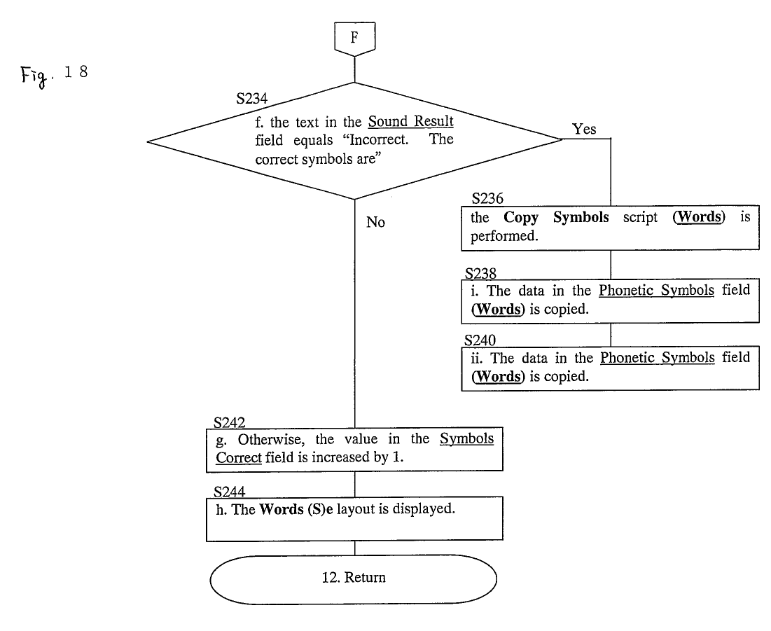

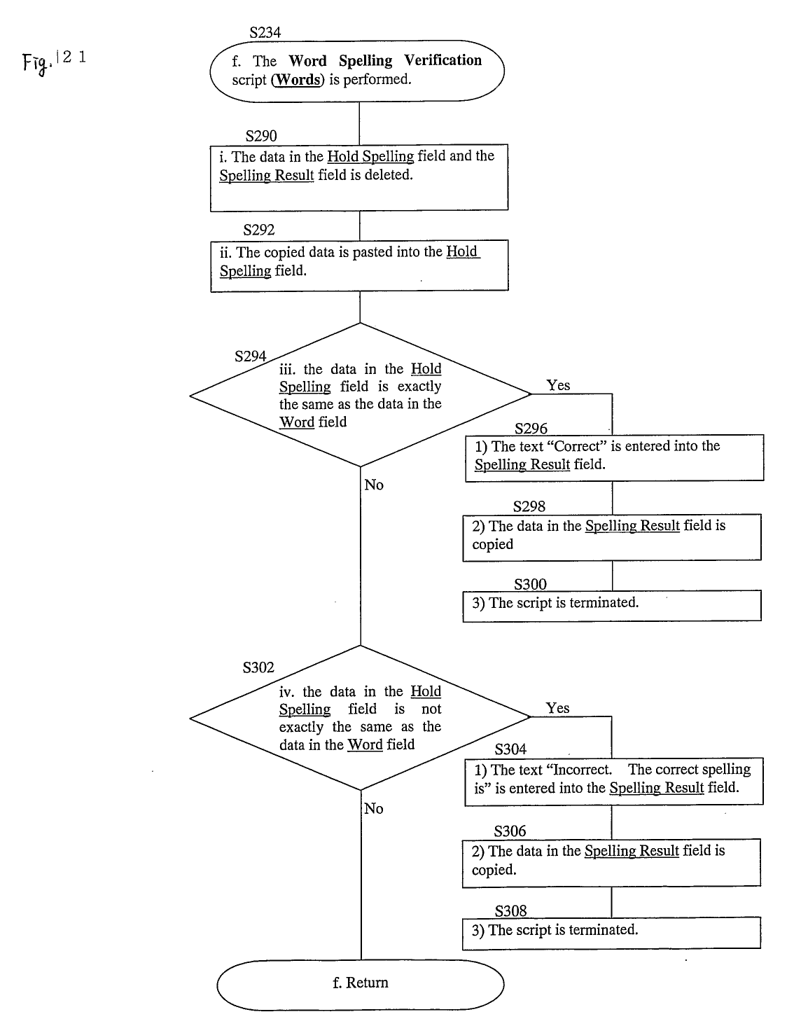

Next, a “Check Spelling of Word(S)” script is executed. The execution button is the “Check” button shown in the screen (S162). This “Check Spelling of Word(S)” script (S162) is described in detail using FIG. 18 to FIG. 23. With regards to FIG. 21 to FIG. 23 in particular, the subscript is further described.

First, if the Word spelling Item 194 is blank (S250), “Enter phonetic symbols of the word before processing” is shown on the screen, and the script is completed (S252).

Second, if the Sound Result Item 150 is blank (S254), “Check the phonetic symbols of the word before proceeding” is shown on the screen, and the script is completed (S256).

Third, if the Word spelling Item 194 is blank (S258), “Enter spelling of the word before processing” is shown on the screen, and the script is completed (S260).

Fourth, if the Word spelling result Item 196 is blank (S262), “Spelling has been checked” is shown on the screen, and the script is completed (S264).

Fifth, data in the Word spelling Item 194 is saved to the temporary memory area part 172.

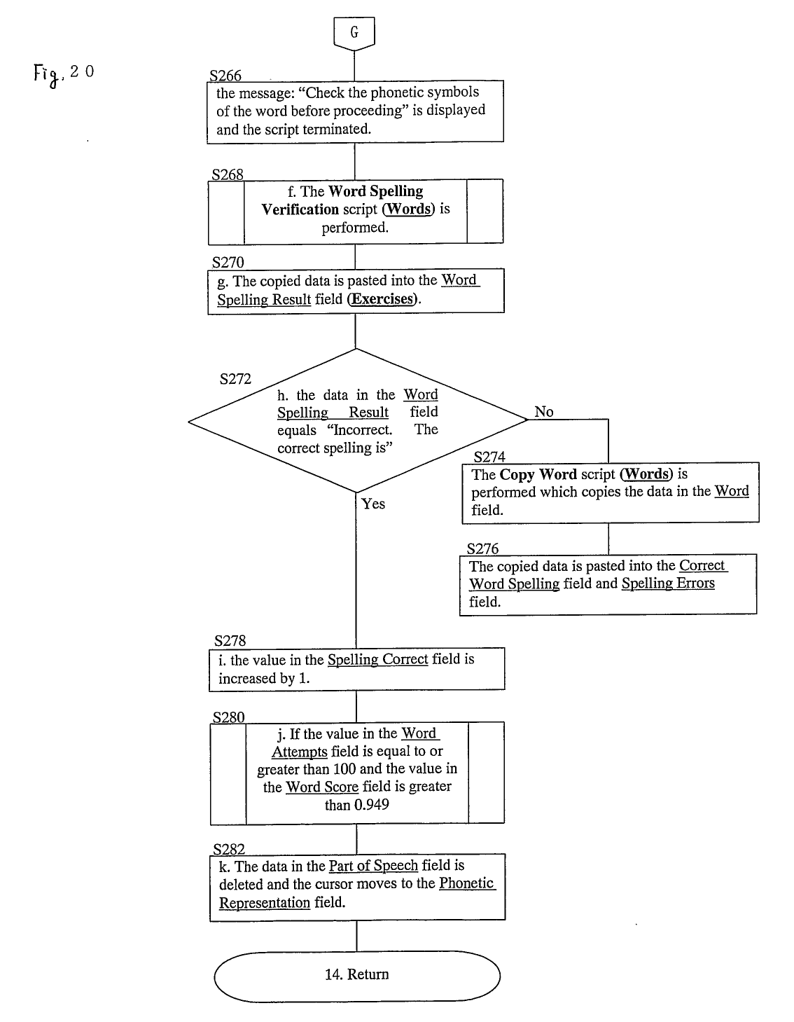

Sixth, the “Word Spelling Verification” script is executed (S268). The details are shown in FIG. 20.

In the “Word Spelling Verification” script, first, the data in the Hold Spelling Item 134 and the Spelling Result Item 222 is deleted as initial setting (S290).

Second, data saved earlier to the temporary memory area part 172 is input to the Hold Spelling Item 134 (S292).

Third, if the data in the Hold Spelling Item 134 is exactly the same as the data in the Word Item 224 (S294), the letters “Correct” are input to the Spelling Result Item 222 (S296).

Fourth, data in the Spelling Result Item 222 is saved to the temporary memory area part 172 (S298).

Then, the script is completed (S300).

In continuation, fifth, if the data in the Hold Spelling Item 134 is not exactly the same as the data in the Word Item 224 (S302), the letters “Incorrect. The correct spelling is” is input to the Spelling Result Item 222 (S304).

Sixth, data in the Spelling Result Item 222 is saved to the temporary memory area part 172 (S306).

Then, the script is completed (S308). Subsequently, it returns once again to step (S268).

On the other hand, data saved earlier to the temporary memory area part 172 is input to the data in the Word spelling result Item 196 (S270).

Next, data in the Word spelling result Item 196 is equal to “Incorrect. The correct spelling is” (S272). “The copy word” script is executed and stored.

The “Copy Word” script (Words) is executed, and the data in Word Item 224 is copied (S724). Then, the data stored to the temporary memory area part 172 are stored to the Correct Word Spelling Item 146 and the Spelling Errors Item 156 (S276).

Here, the value of Spelling Errors Item 156 is increased by 1 (S278).

Next, it the value of Word Attempts Item 158 is more than 100 or equal thereto, the value of word Score Item 226 is more than 0.949 (S280).

Furthermore, the data in Part of Speech Item 140 is deleted, and the cursor moves to the Phonetic Representation Display Block 168 on the screen (S282). Then, it moves to step (S162).

Here, step (S280) is described in further detail using FIG. 21.

First, if the data in the “Select Level” boundary is “4” (S320), “Congratulations! You have completed the fourth and final Word Recognition Test” is shown on the screen (S322).

Second, if the data in the “Select Level” boundary is not “4”, “You have cleared the Words Recognition Test. Go on the next level” is displayed.” is shown on the screen (S324).

Third, if the value of the Select Level Item 132 is n (S326), a “Paste Words Level n Passed” script (Student Records) is executed, and the letters “Passes” is input to the Word Level n Passed Item 228 (S340).

Third, if the value of the Select Level Item 132 is not n (S326), 1 is further subtracted from n (S328), and the process once again progresses to (S326). This is performed until n becomes 1.

Fourth, the letters “Passed” are also input to the Word Level n Passed Item 228 (S342).

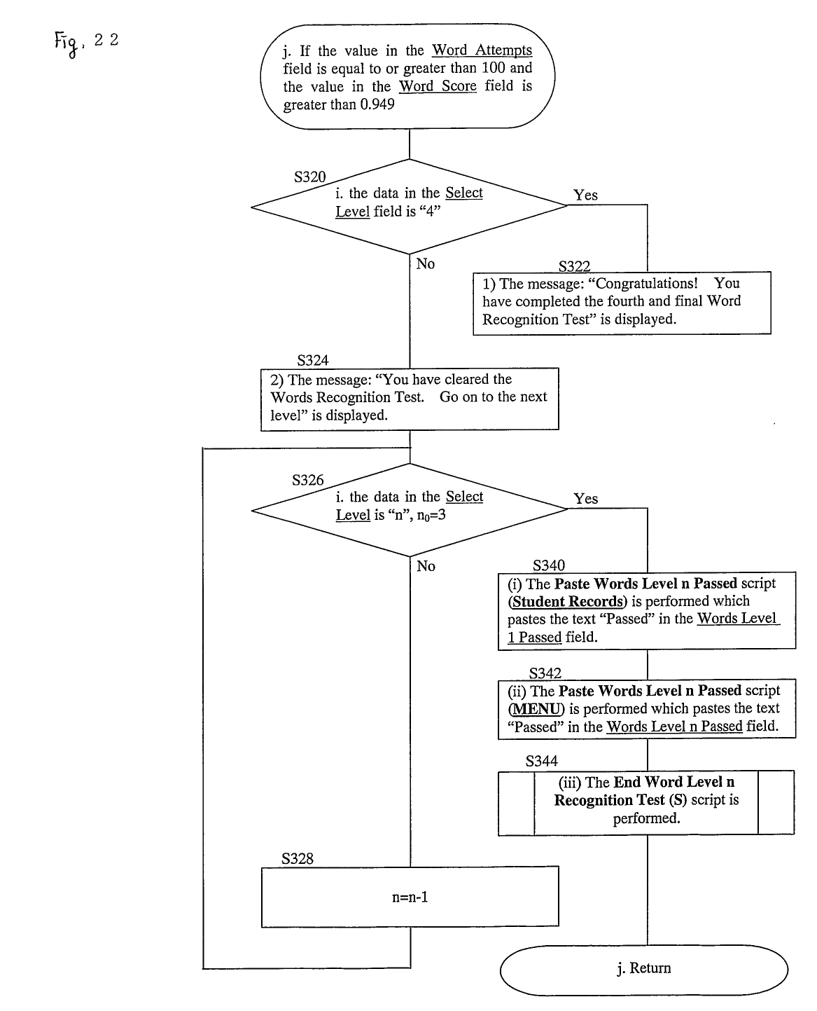

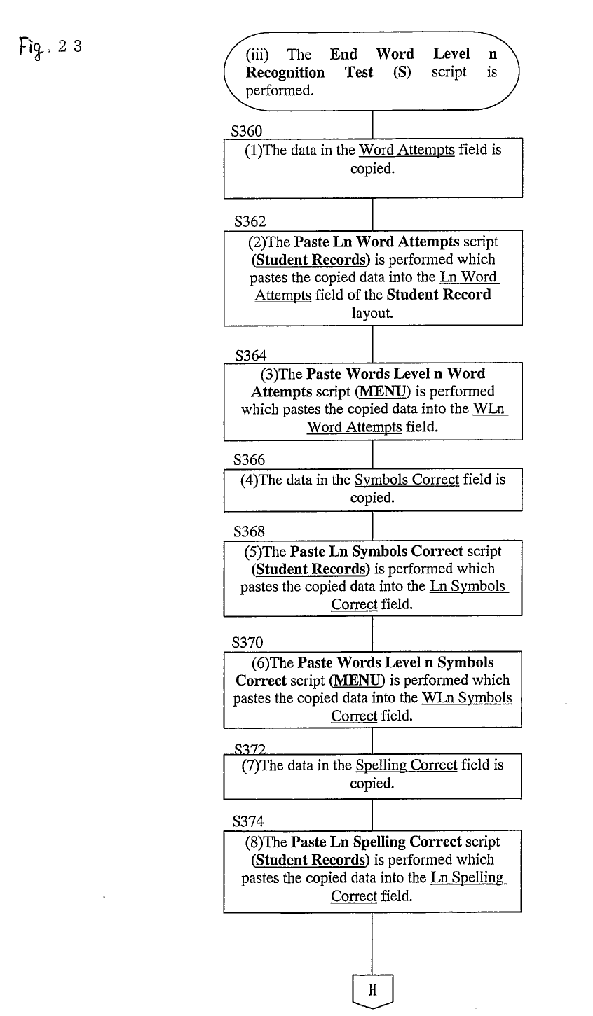

Fifth, an “End Word Level n Recognition Test (S)” script is executed (S344). The details are shown in FIG. 22 and FIG. 23. When this script is completed, the process returns to (S280).

In the “End Word Level n Recognition Test (S)” script, first, data in the Word Attempt Item 174 is saved to the temporary memory area part 172 (S360).

Second, a “Paste Ln Word Level n Recognition Test (S)” script (Student Records) is executed, and the data saved to the temporary memory area part 172 is input to the LN Word Attempt Item 230 in the Student Record layout (S362).

Third, a “Paste Words Level n Attempts” script (MENU) is executed, and the data saved to the temporary memory area part 172 is input within the WLn Word Attempts Item 232 (S364).

Fourth, the data in the Symbols Correct Item 220 is saved to the temporary memory area part 172 (S366).

Fifth, a “Paste Ln Symbols Correct” script (Student Records) is executed, and the data saved to the temporary memory area part 172 is input within the LN Symbols Correct Item 234 (S368).

Sixth, a “Paste Words Level n Symbols Correct” script (MENU) is executed, and the data saved to the temporary memory area part 172 is input within the WLn Symbols Correct Item 236 (S370).

Seventh, the data in the Spelling Correct Item 180 is saved to the temporary memory area part 172 (S372).

Eighth, a “Paste Ln Spelling Correct” script (Student Records) is executed, and the data saved to the temporary memory area part 172 is input within the Ln Spelling Correct Item 238 (S374).

Ninth, a “Paste Words Level n Spelling Correct” script (MENU) is executed, and the data saved to the temporary memory area part 172 is input within the WLn Spelling Correct Item 240 (S376).

Tenth, the data in the Total Correct Item 164 is saved to the temporary memory area part 172 (S378).

Eleventh, a “Paste Ln Total Correct” script (Student Records) is executed, and the data saved to the temporary memory area part 172 is input within the Ln Total Correct Item 242 (S380).

Twelfth, a “Paste Words Level n Total Correct” script (MENU) is executed, and the data saved to the temporary memory area part 172 is input within the WLn Total Correct Item 244 (S382).

Thirteenth, the data in the word Score Item 226 is saved to the temporary memory area part 172 (S384).

Fourteenth, a “Paste Ln Word Score” script (Student Records) is executed, and the data saved to the temporary memory area part 172 is input within the Ln Word Score Item 248 (S388).

Sixteenth, if the value of the Word Attempt Item 174 is 100 or more and the value of the word Score Item 226 is 0.929 or more (S390), the “Paste Words Level n Passed” script (MENU) is executed, and the letters “passed” is input to the Word Level n Passes Item 228.

On the other hand, if the value of the Word Attempt Item 174 is mot 100 or more and the value of the word Score Item 226 is not 0.929 or more, the process returns to step (S344).

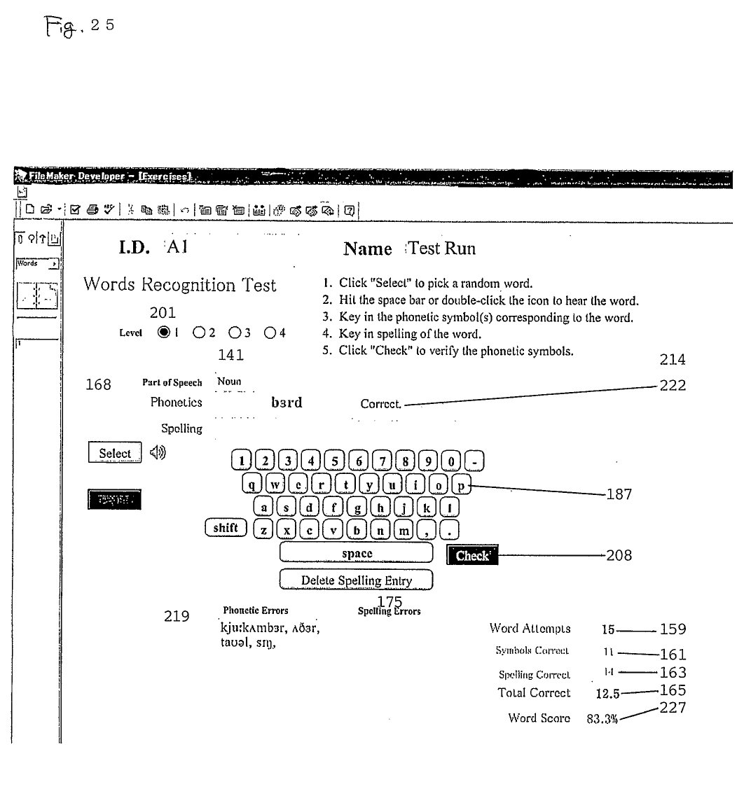

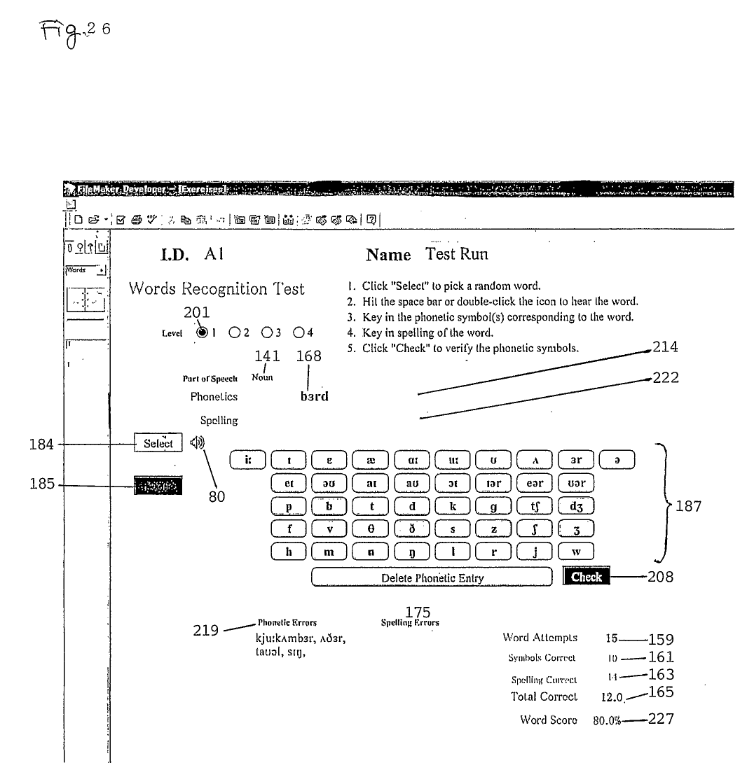

Next, the screen shown on the display when the program in a second embodiment according to the present invention is implemented is described using FIG. 25 and FIG. 26. FIG. 25 shows a screen for entering the spelling of words, and FIG. 26 is a screen for entering the phonetic symbols.

Furthermore, in more detail, the name of the present system and the instructions thereof are shown in the upper row. Furthermore, in this system, there are four levels of questions with differing difficulty, and the level is indicated by the radio button 201.

In the row below, the Part of Speech Display Block 141 showing the part of speech is provided.

Furthermore, in the third row, the Phonetic Representation Display Block 168 is provided, and a block wherein the student enters the answer to the question given by the system is shown.

In the fourth row, below, the Word spelling Display Block 210 is a box to which the phonetic symbols of the same question are input.

In the fifth row are placed the Select button 184, EXIT button 185, alphabet keyboard 187, space key 78, check button 208, Delete Spelling Entry button 209, and in the row further below are the Phonetic Errors Display Block 219, Spelling Errors Display Block 157, Word Attempts Display Block 159, Symbols Correct Display Block 161, Spelling Correct Display Block 163, Total Correct Display Block 165, and word Score Display Block 227.

Here, the Select button 184 is a start button for executing Select Random Word.

EXIT button 185 agrees to end the program.

The alphabet keyboard 187 comprises the 26 letters, comma, colon, number keys, and space key 78 to enter spelling.

The check button 208 determines correct/error of the spelling by clicking after spell input.

The Delete Spelling Entry button 209 is used to delete entered letters.

The Phonetic Errors Display Block 219 shows the errant phonetic symbols of the phonetic symbols tested.

The Spelling Errors Display Block 157 shows the errant spellings of the spellings tested.

The Word Attempts Display Block 159 is a block showing the number of attempts made on the test.

The Symbols Correct Display Block 161 shows Symbols Correct of which the value is counted when the phonetic symbol is correct.

The Spelling Correct Display Block 163 shows Spelling Correct of which the value is counted when the spelling is correct.

The Total Correct Display Block 165 shows Total Correct which is the number of correct answers when all answers are correct.

The word Score Display Block 227 shows the percentage of the correct answers wherein the value of the Total Correct Display Block 165 is divided by the value of the Word Attempts Display Block 159.

FIG. 26 differs only in that a phonetic keyboard is placed in place of the alphabet keyboard.

Through the foregoing configuration, a system can be provided wherein skills for accurately catching the pronunciation of words can be obtained, while learning to spell at the same time.

1-7. (canceled)

8. A phonetic pronunciation training device comprising at least a data base for storing phonetic pronunciation data associated with phonetic data and phonetic symbol data indicating this phonetic data, a selection function block for receiving instruction signal from an input means and randomly selecting phonetic pronunciation data, a phonetic pronunciation data reproducing function for reproducing selected phonetic pronunciation data, and a phonetic symbol data correct/error determination function block for comparing phonetic symbol data input by the input means and phonetic symbol data corresponding to the selected phonetic pronunciation data and recording the correct/error result to a memory means and a calculation function block for adding the correct/error results determined by the phonetic symbol data correct/error determination function block and calculating the correct/error rates and comparison frequency.

9. The phonetic pronunciation training device according to claim 8 wherein said phonetic symbol data is further characterized by letter data corresponding to phonetic symbol data being recorded to the database, and the correct/error determination function block comparing the character data input from an outside source and the character data corresponding to the selected phonetic pronunciation data and recording this correct/error result to the memory means.

10. The phonetic pronunciation training device according to claim 8 further comprising a display function block for displaying the calculation results from the calculation function block to the display part.

11. The phonetic pronunciation training device according to claim 8 further comprising an access management function block for recording, to the memory means, the correct/error rates and comparison frequency calculated by the calculation function block for every person making an access.

12. A phonetic pronunciation training method wherein phonetic pronunciation data associated with sound data and phonetic symbol data indicating this sound data is stored to the database beforehand, a selection function block receives instruction signals from an input means and randomly selects phonetic pronunciation data, a phonetic pronunciation data reproducing function block reproduces the selected phonetic pronunciation data, and a phonetic symbol data correct/error determination function block compares the phonetic symbol data input from the input means and the phonetic symbol data corresponding to the selected phonetic pronunciation data and records the correct/error results to the memory means.

13. A phonetic pronunciation training program wherein phonetic pronunciation data associated with sound data and phonetic symbol data indicating this sound data is stored to the database beforehand, the selection
